(19) United States
(12) Patent Application Publication
(10) Pub. No.: US 2007/0149078 A1
(43) Pub. Date: Jun. 28, 2007

(54) Perforated non-woven fiberglass mat

(76) Inventors: Malay Nandi, Littleton, CO (US); Gaurav Agrawal, Aurora, CO (US)

Correspondence Address: JOHNS MANVILLE, 10100 WEST UTE AVENUE, LITTLETON, CO, 80127, US

(21) Appl. No.: 11/315,737

(22) Filed: Dec. 22, 2005

(51) Int. Cl. B32B 17/02; B32B 17/04

(52) U.S. Cl. 442/180

(57) ABSTRACT

A novel nonwoven fiberglass mat having properties particularly suited for a facer on gypsum wallboard, laminates made therefrom and the method of making the mat is disclosed. The mat has a controlled permeability, with the permeability of the mat being controlled by perforation of the mat.

### BACKGROUND OF THE INVENTION

1. Field of the Invention

The invention relates to an improved faced board material employing a fibrous mat facer wherein the board displays smooth attractive surface characteristics combined with good structural integrity.

2. Description of the Related Art

Faced boards formed from cementitious material are typically used in the construction of modern buildings, for example, as surfaces for both interior and exterior walls and ceilings and the like. Such boards are typically relatively easy and inexpensive to install, finish, and maintain, and in suitable forms, can be relatively fire resistant.

For instance, wallboard formed of a gypsum core sandwiched between facing layers is used in the construction of virtually every modern building. In its various forms, the material is employed as a surface for walls and ceilings and the like, both interior and exterior.

Although paper-faced wallboard is most commonly used for finishing interior walls and ceilings, other forms with different kinds of facings have superior properties that are essential for other uses. One known facing material is a nonwoven fiberglass mat.

Gypsum wallboard and gypsum panels are traditionally manufactured by a continuous process. In this process, a gypsum slurry is first generated in a mechanical mixer by mixing at least one of anhydrous calcium sulfate (CaSO₄) and calcium sulfate hemihydrate (CaSO₄.1/2H₂O, also known as calcined gypsum), water, and other substances, which may include set accelerants, waterproofing agents, reinforcing mineral, glass fibers, and the like. The gypsum slurry is normally deposited on a continuously advancing, lower facing sheet, such as kraft paper. Various additives, e.g., cellulose and glass fibers, are often added to the slurry to strengthen the gypsum core once it is dry or set. Starch is frequently added to the slurry in order to improve the adhesion between the gypsum core and the facing. A continuously advancing upper facing sheet is laid over the gypsum and the edges of the upper and lower facing sheets are pasted to each other with a suitable adhesive. The facing sheets and gypsum slurry are passed between parallel upper and lower forming plates or rolls in order to generate an integrated and continuous flat strip of unset gypsum sandwiched between the sheets. The strip is conveyed over a series of continuous moving belts and rollers for a period of several minutes, during which time the core begins to hydrate back to gypsum (CaSO₄.2H₂O). The process is conventionally termed “setting,” since the rehydrated gypsum is relatively hard.

After the cutting step, the gypsum boards are fed into drying ovens or kilns so as to evaporate excess water. Inside the drying ovens, the boards are blown with hot drying air. After the dried gypsum boards are removed from the ovens, the ends of the boards are trimmed off and the boards are cut to desired sizes. The boards are commonly sold to the building industry in the form of sheets nominally 4 feet wide and 8 to 12 feet or more long and in thicknesses from nominally about ¼ to 1 inches, the width and length dimensions defining the two faces of the board. During the drying process, it is important that water vapor be allowed to escape, otherwise blistering of the board may occur.

While paper is widely used as a facing material for gypsum board products because of its low cost, many applications demand water resistance that paper facing cannot provide. Upon exposure to water either directly in liquid form or indirectly through exposure to high humidity, paper is highly prone to degradation, such as by delamination, that substantially compromises its mechanical strength. Gypsum products typically rely on the integrity of the facing as a major contributor to their structural strength. Consequently, paper-faced products are generally not suited for exterior or other building uses in which exposure to moisture conditions is presumed.

In addition, there is growing attention being given to the issue of mold and mildew growth in building interiors and the potential adverse health impact such activity might have on building occupants. The paper facing of conventional gypsum board contains wood pulp and other organic materials that may act in the presence of moisture or high humidity as nutrients for such microbial growth. A satisfactory alternative facing material less susceptible to growth is highly sought.

A further drawback of paper-faced gypsum board is flame resistance. In a building fire, the exposed paper facing quickly burns away. Although the gypsum itself is not flammable, once the facing is gone the board's mechanical strength is greatly impaired. At some stage thereafter the board is highly likely to collapse, permitting fire to spread to the underlying framing members and adjacent areas of a building, with obvious and serious consequences. A board having a facing less susceptible to burning would at least survive longer in a fire and thus be highly desirable in protecting both people and property.

To overcome these and other problems, a number of alternatives to paper facing have been proposed. U.S. Pat. No. 4,647,496 discloses an exterior insulation system including a fibrous mat-faced gypsum board having a set gypsum core that is water-resistant. The fibrous mat is preferably sufficiently porous for the water in the gypsum slurry to evaporate during the production drying operation as the gypsum sets. The mat comprises fibrous material that can be either mineral-type or a synthetic resin. One preferred mat comprises nonwoven glass fibers, randomly oriented and secured together with a modified or plasticized urea-formaldehyde resin binder, and sold as DURA-GLASS® 7502 by the Manville Building Materials Corporation.

Another form of mat-faced gypsum board is known from U.S. Pat. No. 4,879,173, which discloses a mat of nonwoven fibers having a reinforcing resinous binder that can comprise a single resin or a mixture of resins, either thermoplastic or thermosetting. Exemplary resins disclosed include a styrene-acrylic copolymer and a self-crosslinking vinyl acetate-acrylic copolymer. A small amount of the binder is applied to the surface of the mat and penetrates but part of the way therethrough. The board is said to be useful as a support member in a built-up roof. The highly textured surface of the mat binder provides many interstices into which can flow an adhesive used to adhere an overlying component. However, considerable care is required in using a mat containing substantial numbers of voids as a facer for gypsum board. Conventional processing that incorporates deposition of a relatively wet slurry is generally found to result in considerable intrusion of the slurry through the mat and onto the faced surface, which is frequently undesirable. Prevention of this excess intrusion typically requires very careful control of the slurry viscosity, which, in turn, frequently leads to other production problems. Alternative mats, which inherently limit intrusion, yet still have sufficient permeability to permit water to escape during the formation and heat drying of the gypsum board are thus eagerly sought as a simpler alternative.

It is an object of the present invention to provide an improved faced board material employing a fibrous mat facer wherein the board displays smooth attractive outer surface characteristics combined with good structural integrity.

Also, there exists a need for providing a facer for use in a cementitious board, having an improved resistance to bleed-through of a cementitious slurry during the manufacture of the board.

Other objects of the present invention will become apparent to those skilled in the art upon a review of the following description and appended claims.

### SUMMARY OF THE INVENTION

According to one aspect, a process for producing a board suitable for use as a wallboard or a ceiling panel is provided, comprising:

(a) providing a substrate comprising a first facer;

(b) applying a slurry comprising a cementitious material on the substrate; and

(c) providing a second facer above the slurry,

wherein at least one of the first and second facers further comprises a perforated glass mat.

According to another aspect, a board suitable for use as a wallboard or a ceiling panel is provided, comprising:

(a) a layer comprising a cementitious material, and having a first face and a second face; and

(b) first and second facers arranged adjacent to or in contact with the first and second faces of the layer comprising a cementitious material, wherein at least one facer comprises a perforated glass mat.

### DETAILED DESCRIPTION OF THE PREFERRED EMBODIMENTS

It is known to make non-woven mats from glass fibers and to use these mats as substrates in the manufacture of a large number of roofing and other products. Any known method of making non-woven glass fiber mats can be used, such as the conventional wet laid processes described in U.S. Pat. Nos. 4,129,674; 4,112,174; 4,681,802; 4,810,576 and 5,484,653, the disclosures of each being hereby incorporated herein by reference. In these processes a slurry of glass fiber is made by adding glass fiber to typical white water in a pulper to disperse the fiber in the white water and to form a slurry having a fiber concentration of about 0.2-1.0 wt. %, metering the slurry into a flow of white water to dilute the fiber concentration to 0.1 wt. % or less, and continuously depositing this mixture onto a moving screen forming wire to dewater and form a wet non-woven fibrous mat. This wet non-woven mat is then conveyed through a binder application where an aqueous resinous binder is applied in excess, the surplus being removed by suction. The wet, bindered mat is then dried and the binder cured to form a non-woven mat product.

The method of U.S. Pat. No. 4,129,674, employs a wet-laid, inclined wire screen mat-forming machine. Generally stated, the method comprises forming a slurry, preferably a water slurry, containing the requisite fibers. The solids content of such a slurry may be very low, such as approximately 0.2%. The slurry is intensely mechanically agitated to disperse the fibers uniformly therein and then dispensed onto a moving screen. A vacuum is applied to remove a substantial part of the water, which is preferably recycled, and thereby form a web of the fibers. After application of a binder, the web is heated to evaporate any remaining water and cure the binder, thus forming the bonded mat. Preferably, the mat-forming process is carried out in a continuous operation. The moving screen is provided as a continuous conveyor-like loop and is slightly upwardly inclined during the portion of its travel in which the fiber slurry is deposited thereon. Subsequently, a binder is applied and the mat heated to effect final drying and curing. After the vacuum step is completed, the web is optionally transferred to one or more additional downstream conveyor systems for binder application and passage through a heated oven for the final drying and curing operation. Machines suitable for carrying out such a web-forming process are available commercially and include devices manufactured under the tradenames Hydroformer™ by Voith-Sulzer of Appleton, Wis., and Deltaformer™ by Valmet/Sandy Hill of Glens Falls, N.Y.

Preferably, the majority of the fibers in the non-woven mat are glass fibers, and most preferably all the fibers are glass fibers. However, this invention is equally applicable to ceramic, natural, wood pulp like, manmade cellulousic fibers and polymeric fibers, and to non-woven webs made from mixtures of any combination of these types of fibers. While the majority of the fibers are glass fibers in the preferred embodiment, all or any portion of non-glass fibers can also be included, such as manmade or natural organic fibers like nylon, polyester, polyethylene, polypropylene, cellulose or cellulose derivatives, etc.

The fibers used in the non-woven mat should be at least 0.25 inch long or longer, more preferably at least one half inch or three quarters inch long and most preferably at least about one inch long, but mixtures of fibers of different lengths and/or fiber diameters can be used as is known. It is preferred that these fibers be coated with a silane containing size composition as is well known in the industry. A preferred continuous glass fiber for fibrous web is at least one member selected from the group consisting of E, C, and T type and sodium borosilicate glasses, and mixtures thereof. As is known in the glass art, C glass typically has a soda-lime-borosilicate composition that provides it with enhanced chemical stability in corrosive environments, and T glass usually has a magnesium aluminosilicate composition and especially high tensile strength in filament form. The present mat is preferably composed of E glass, which is also known as electrical glass and typically has a calcium aluminoborosilicate composition and a maximum alkali content of 2.0%. E glass fiber is commonly used to reinforce various articles. The chopped fibers of the major portion can have varying lengths, but more commonly are substantially of similar length. E glass fiber has sufficiently high strength and other mechanical properties to produce acceptable mats and is relatively low in cost and widely available. Most preferred is E glass having an average fiber diameter of about 11.+−.1.5 μm and a length ranging from about 6 to 12 mm.

The aforementioned glass fibers are bound together with any known water resistant resinous binder. Suitable binders include urea formaldehyde; conventional modified urea formaldehyde; acrylic resins; melamine resins, preferably having a high nitrogen resins such as those disclosed by U.S. Pat. No. 5,840,413; homopolymers or copolymers of polyacrylic acid having a molecular weight of less than 10,000, preferably less than 3,000; crosslinking acrylic copolymer having a glass transition temperature (GTT) of at least about 25° C., crosslinked vinyl chloride acrylate copolymers having a GTT preferably no higher than about 113° C.; and other known flame and water resistant conventional mat binders. It is typically found that a lower GTT promotes better softness and smoothness of the mat surface, but tensile strength is improved with a higher GTT. Binder systems having a GTT ranging from about 15 to 45° C. are thus preferred. Aqueous modified and plasticized urea formaldehyde resin binders may be used and have low cost and acceptably high performance.

A preferred binder for the present mat comprises an acrylate copolymer binder latex with a GTT of about 25° C. available from Noveon, Inc. of Cleveland, Ohio, under the tradename Hycar™ 26138. As delivered, this acrylate copolymer latex has a solids content of about 50 weight percent solids, but it is preferred to dilute the concentration with water to about 25 wt. percent solids before using it. Preferably up to about 10 weight percent of a crosslinker such as melamine formaldehyde is added to the acrylate; and more preferably about 2-5 weight percent crosslinker is added. Advantageously, mat bound with the acrylate copolymer latex is smoother and the mat thinner for equivalent weight and properties than with other known binders. In addition, expensive fluorochemical emulsions needed in certain prior art binders are not required.

The amount of acrylate copolymer latex binder (and any optional cross-linker) left in the wet mat during manufacture can be determined by a loss on ignition (LOI) test, the result thereof being specified as a percentage of the dry weight of the finished mat. Generally, the amount of binder in the final mat, based on its dry weight, ranges from about 15 to 35 wt. percent, with about 20-30 wt. percent being more preferred, and 25.+−.2.5 wt. percent being most preferred. The upper limit is normally dictated by process constraints and cost, while the minimum is required for adequate tensile strength. In the present invention, however, the binder is used to first close the mat, i.e., little or no air permeability as defined by having a “Gurley” measurement of greater than 200 seconds. Therefore, the amount of binder employed is generally in the 20-50 wt. % range, with the higher percentages above 30 wt. % being preferred. Also, the viscosity of the aqueous solution containing the binder can be controlled to achieve the closed mat. Normally, the viscosity is in the range of from 20-100 cps, however, a viscosity in the range of from 100-400 cps is preferred, more preferably 125-350 cps.

The aqueous binder solution is preferably applied using a curtain coater or a dip and squeeze applicator. Normally, the mat is subjected to temperatures of about 120-330° C. for periods usually not exceeding 1 or 2 minutes, and frequently less than 40 seconds, for the drying and curing operations. Alternative mat forming methods useful in forming mat for the present invention include the use of well-known cylinder forming and “dry laying.”

Optionally the fibrous mats of the present invention further contain fillers, pigments, or other inert or active ingredients either throughout the mat or concentrated on a surface. For example, the mat can contain an effective amount of fine particles of limestone, glass, clay, coloring pigments, biocide, fungicide, intumescent material, or mixtures thereof. Such additives may be added for known structural, functional, or aesthetic qualities imparted thereby. These qualities include coloration, modification of the structure or texture of the surface, resistance to mold or fungus formation, and fire resistance. Preferably, flame retardants sufficient to provide flame resistance, e.g. according to NFPA Method 701 of the National Fire Protection Association or ASTM Standard E84, Class 1, by the American Society for the Testing of Materials, are added. Biocide is preferably added to the mat and/or gypsum slurry to resist fungal growth, its effectiveness being measurable in accordance with ASTM Standard D3273. The mats and gypsum layer of the present invention preferably have a very low cellulosic fiber content from which microbes could derive nutrition. More preferably any cellulosic fiber present in the mats or gypsum is only an impurity of other ingredients.

The mat is set and dried, and then perforated. The perforations are controlled such that the permeability of the mat is sufficient to allow water vapor to escape, but still provide a barrier to water. Thus, the permeability can be measured using many different known methods, e.g., it can be measured in second of a known amount of air mass to pass through the web, as measured by instruments such as the “Gurley Densonator”. Generally, the coated mat is perforated such that the air permeability is less than 60 seconds, and more preferably less than 50 seconds, and most preferably less than 40 seconds and in the range of from about 20-40 seconds. The air permeability of a mat can also be conventionally measured by the air flow between reservoirs separated by the mat using a test called the Frazier test, which is further described by ASTM Standard Method D737, with the results ordinarily being given in units of cubic feet per minute per square foot (cfm/ft²). The test is usually carried out at a differential pressure of about 0.5 inches of water. In preferred embodiments, the permeability of the present mat, as measured by the Frazier method, is at least about 250, and more preferably, at least about 300 cfm/ft²

The mechanism for perforating the fiberglass mat can be any suitable mechanism. Preferably, the perforations are not random but in a pattern to allow permeation of water vapor through the fiberglass mat and attached substrate. The preferred mechanism is a roll mounted to a drive shaft which has numerous “needles” attached to the roll. These needles can vary in diameter from less than 0.1″ to over 0.05″. The needle length can vary depending on the application from less than 0.01″ to over 0.3″. The needles can be made of metal or a non-metallic material. The roll diameter can vary depending on the application from less than 4″ to over 20″. The roll length can vary depending on product width from less than 3″ to over 18″ in length. A back up roll or anvil roll may be used depending on the application. The anvil roll, if used, may be covered in a resilient surface.

The ability of the present invention to control the permeability without employing a coating has great cost advantage. A controlled permeability is needed for downstream converting processes, particularly when the non-woven web is used as a facer for a gypsum board. A highly permeable facer would lead to bleed through of underlying material such as gypsum in a wallboard converting process, whereas very low permeability would lead to moisture being trapped in the downstream converting process of a gypsum board. The present invention permits one to control the permeability by first closing the mat so it has little if any permeability, and then perforating the mat in a controlled manner to achieve the desired permeability as discussed above. In a preferred embodiment, the fiber mats of the present invention comprise a perforated, non-woven web bonded together with a resinous binder with the mat being used for one or both of the large faces of gypsum board. In a preferred embodiment, the mat comprises primarily glass fibers, and in a most preferred embodiment, the web comprises chopped continuous glass fibers, of which preferably at least about 90 percent, more preferably at least about 95 percent, and most preferably at least about 97 percent have a fiber diameter of less than 30 μ, and more preferably within a narrow range of about 11.±.1.5 μm. Although mixtures of different lengths of chopped strand fibers are contemplated and included within the scope of the invention, it is most preferred that a majority of the fibers have lengths greater than 2 mm, and more preferably lengths of 12.±.6 mm. The present web also includes a small fraction of fibers that are broken into two or more pieces and a very small fraction of small glass fibers and chips. The presence of such broken and chipped fibers in a chopped fiber product is well known in the fiber industry.

It is also preferred that the binder used for the present mats comprise an effective amount of a water repellant to limit the intrusion of gypsum slurry during board production. For example, vinyl acrylate latex copolymers may further incorporate stearylated melamine for improvement in water repellency, preferably at a level ranging from about 3 to 10 wt. %, and more preferably at about 6 wt. %. A suitable aqueous stearylated melamine emulsion is available from the Sequa Chemical Corporation, Chester, S.C., under the tradename SEQUAPEL™ 409. The stearylated melamine is in liquid form having a solids content of about 40 wt. percent and is mixed with a suitable copolymer latex and water to prepare binders for the mats. This material mixture has a pH of about 9, a viscosity of about 45 centipoises and is anionic. In addition, gypsum board incorporating mat with the preferred binder is more resistant to abrasion than conventional either fiber-faced or paper-faced boards.

Gypsum board in accordance with the present invention preferably is faced with a mat having a basis weight ranging from about 0.6 to 2.2 pounds per 100 square feet, more preferably ranging from about 0.9 to 2.2 lbs./100 sq. ft., and most preferably about 1.25.+−.0.2 lbs./100 sq. ft. (about 29-110, 45-110, and 60.+−.10 g/m², respectively). Preferably the binder content of the dried and cured mats ranges from about 10 to 35 wt. percent, more preferably from about 15 to 30 wt. percent, and most preferably from about 25.+−.3 wt. percent, based on the weight of the finished mat. The basis weight must be large enough to provide the mat with sufficient tensile strength for producing quality gypsum board. At the same time, the binder content must be limited for the mat to remain sufficiently flexible to permit it to be bent to form the corners of the board. Furthermore, too thick a mat renders the board difficult to cut during installation. Such cuts are needed both for overall size and to fit the board around protrusions such as plumbing and electrical hardware.

The utility of the present mat is advantageous due to its controlled permeability. During the gypsum board formation process, far more water is present in the gypsum slurry than is stochiometrically needed to drive the gypsum rehydration reaction. The excess is removed during a drying operation, and preferably escapes through the facings. The facers of the present invention have sufficient permeability to allow the drying to be accomplished within an acceptable time period and without bubbling, delamination, or other degradation of the facer.

The invention further provides a method for making gypsum board and other hydraulic set and cementitious board products for interior and/or exterior use, i.e. products appointed for installation on either interior or exterior surfaces of building structures. By exterior surface is meant any surface of a completed structure expected to be exposed to weather; by interior surface is meant a surface within the confines of an enclosed, completed structure and not intended to be exposed to weather. The above-described non-woven, fibrous mat is present on at least one of the large faces of the gypsum board.

Gypsum wallboard and gypsum panels are traditionally manufactured by a continuous process. In this process, a gypsum slurry is first generated in a mechanical mixer by mixing at least one of anhydrous calcium sulfate (CaSO₄) and calcium sulfate hemihydrate (CaSO₄1/2H₂O, also known as calcined gypsum), water, and other substances, which may include set accelerants, waterproofing agents, reinforcing mineral, glass fibers, and the like. The gypsum slurry is normally deposited on a continuously advancing, lower facing sheet, such as kraft paper. Various additives, e.g. cellulose and glass fibers, are often added to the slurry to strengthen the gypsum core once it is dry or set. Starch is frequently added to the slurry in order to improve the adhesion between the gypsum core and the facing. A continuously advancing upper facing sheet is laid over the gypsum and the edges of the upper and lower facing sheets are pasted to each other with a suitable adhesive. The facing sheets and gypsum slurry are passed between parallel upper and lower forming plates or rolls in order to generate an integrated and continuous flat strip of unset gypsum sandwiched between the sheets. Such a flat strip of unset gypsum is known as a facing or liner. The strip is conveyed over a series of continuous moving belts and rollers for a period of several minutes, during which time the core begins to hydrate back to gypsum (CaSO₄2H₂O). The process is conventionally termed “setting,” since the rehydrated gypsum is relatively hard. During each transfer between belts and/or rolls, the strip is stressed in a way that can cause the facing to delaminate from the gypsum core if its adhesion is not sufficient. Once the gypsum core has set sufficiently, the continuous strip is cut into shorter lengths or even individual boards or panels of prescribed length.

After the cutting step, the gypsum boards are fed into drying ovens or kilns so as to evaporate excess water. Inside the drying ovens, the boards are blown with hot drying air. After the dried gypsum boards are removed from the ovens, the ends of the boards are trimmed off and the boards are cut to desired sizes. The boards are commonly sold to the building industry in the form of sheets nominally 4 feet wide and 8 to 12 feet or more long and in thicknesses from nominally about ¼ to 1 inches, the width and length dimensions defining the two faces of the board.

The gypsum board production method can comprise the steps of: forming an aqueous slurry comprising at least one of anhydrous calcium sulfate, calcium sulfate hemi-hydrate, or cement; distributing the slurry to form a layer on a first facing; applying a second facing onto the top of the layer; separating the resultant board into individual articles; and drying the articles. The fibers in the web are bound together with a polymeric binder. Alternatively, the slurry may be distributed to form a layer between two facings. The slurry optionally includes reinforcing fibers or other known additives used as process control agents or to impart desired functional properties to the board, including one or more of agents such as biocides, flame retardants, and water repellents. The product of the invention is ordinarily of a form known in the building trades as board, i.e. a product having a width and a length substantially greater than its thickness. Gypsum and other hydraulic set and cementitious board products are typically furnished commercially in nominal widths of at least 2 feet, and more commonly 4 feet. Lengths are generally at least 2 feet, but more commonly are 8-12 feet.

Having thus described the invention in detail, it will be understood that such detail need not be strictly adhered to, but that additional changes and modifications may suggest themselves to one skilled in the art, all falling within the scope of the invention as defined by the subjoined claims.

What is claimed is:

1. A process for producing a board suitable for use as a wallboard or a ceiling panel, comprising:
(a) providing a substrate comprising a first facer;
(b) applying a slurry comprising a cementitious material on the substrate; and
(c) providing a second facer above the slurry
wherein at least one of the first and second facers further comprises a perforated glass mat.

2. The process according to claim 1, wherein the cementitious material is selected from the group consisting of gypsum, Portland cement, a pozzolanic material and a combination thereof.

3. The process according to claim 1, wherein the at least one facer comprising the perforated glass mat has a Gurley permeability of about 60 seconds or less.

4. The process according to claim 1, wherein each of the first and second facers comprises a perforated glass mat.

5. A board suitable for use as a wallboard or a ceiling panel, comprising:
(a) a layer comprising a cementitious material, and having a first face and a second face; and
(b) first and second facers arranged adjacent to or in contact with the first and second faces of the layer comprising a cementitious material, wherein at least one facer comprises a perforated glass mat layer.

6. The board according to claim 5, wherein cementitious material is selected from the group consisting of gypsum, Portland cement, a pozzolanic material and a combination thereof.

7. The board according to claim 5, wherein the at least one facer comprising the laminate layer has a Gurley permeability of about 60 seconds or less.

8. A perforated, uncoated, non-woven fiberglass mat.

9. The mat of claim 8, wherein the mat has a Gurley permeability of about 60 seconds or less.

10. A method for preparing the fiberglass mat of claim 8, which comprises:
a) preparing a closed, non-woven fiberglass mat, and
b) perforating the closed fiberglass mat.

11. The method of claim 10, wherein the mat is mechanically perforated.

12. The method of claim 10, wherein the mat is perforated to thereby achieve a Gurley permeability of 60 seconds or less.
